(19) United States
(12) Patent Application Publication
(10) Pub. No.: US 2008/0015288 A1
(43) Pub. Date: Jan. 17, 2008

(54) Method for Preparing a Bitumen-Polymer Mixture

(75) Inventors: Jean-Pierre Antoine, Francheville (FR); Jerome Marcilloux, Saint-Symphorien d'Ozon (FR)

Correspondence Address: OBLON, SPIVAK, MCCLELLAND MAIER & NEUSTADT, P.C., 1940 DUKE STREET, ALEXANDRIA, VA, 22314, US

(73) Assignee: EIFFAGE TRAVAUX PUBLICS, NEUILLY SUR MARNE FRANCE (FR)

(21) Appl. No.: 11/629,488

(22) PCT Filed: Jun. 9, 2005
(86) PCT No.: PCT/FR05/01432

§ 371 Date: Dec. 14, 2006

(30) Foreign Application Priority Data
Jun. 16, 2004 (FR) 0406525

(51) Int. Cl. C08L 31/02; C08L 23/04; C08L 23/12; C08L 23/32

(52) U.S. Cl. 524/69; 524/59; 524/70

(57) ABSTRACT

The invention concerns a method which consists in preparing by extrusion a master batch containing bitumen and a high concentration of a polymer such as a styrene-butadiene-styrene copolymer, which is then diluted into the bitumen to produce a bituminous binder. The invention is useful for making bituminous binders for spraying or embedding.

The invention relates to a method for preparing a mixture containing bitumen and at least one polymer.

Pure bitumens from the refinery are currently used to produce anhydrous binders or emulsified binders for use on roads. In order to reduce the heat sensitivity of these bitumens, increase their cohesion or elasticity and consequently improve the behaviour of the binder under high stresses, the use of polymers dispersed in the bitumen is also common.

This incorporation is generally carried out in dedicated factories containing agitated heated vats connected to systems for supplying them with bitumen, polymer and additives, as well as storage vats in which the binder can be mixed, thus helping it to mature if necessary.

Depending on the level of modification required, cross-linking or dispersing systems may or may not be used. Furthermore, the length of time needed for the dispersion may vary greatly, considerably affecting the production rates and costs. The use of certain additives may have a substantial environmental impact.

All these considerations involve investments, some of them substantial, for each production site.

The heating of the mixing vats which in some cases may contain more than 50 m³ requires considerable amounts of energy, a situation which will be repeated in each factory.

The ongoing tightening up of the requirements, the proximity of working sites requiring large quantities of binders and the rationalisation of the industrial tools mean that the production capacities have to be extended and these industrial sites have to be more flexible. In addition to the extra investment costs corresponding to these new requirements, the need to heat and agitate larger volumes or to increase the number of batches per day has a major environmental impact in terms of both energy consumption and atmospheric pollution.

In order to limit these extra costs and environmental impacts, one solution is to produce premixes known as master batches. These mixes are currently used to produce binders for surface coatings. In this case the use of products that dissolve bitumen, known as fluxes or plasticisers, enables the polymer to be predissolved in large amounts at temperatures compatible with the flashpoint of these fluxes, as well as allowing the binder to be pumped subsequently. The polymers most frequently used in bitumens are styrene and butadiene copolymers, which may be statistical, bisequenced or trisequenced. The copolymers of ethylene and vinyl acetate are also commonly used. Other polymers are used to a marginal degree.

After the dispersion of the master batch in the bitumen the binder obtained has characteristics very similar to those of an equivalent binder obtained by the conventional method, i.e. by the successive addition of polymer and then flux to the bitumen.

In the case of coating binders the situation is more tricky. In fact these binders do not contain any flux and premixing by conventional methods incorporating large amounts of polymers presents a problem of viscosity and consequently requires a long manufacturing time.

With conventional technologies contents in excess of 20% are virtually unimaginable.

FR 2 619 821 A describes the incorporation of rubber particles in binders and/or bituminous mixtures.

The poor compatibility of these particles with the bitumen most often requires the use of supplementary additives intended to improve this compatibility, but their incorporation makes the manufacturing time longer.

Finally, other polymers such as polyethylenes, polypropylenes and other polyolefins may usefully be added to the bituminous mixture so as to improve the resistance to rutting or to hydrocarbons. These polymers are not miscible with the bitumen and are therefore added directly to the bituminous mixture during the mixing process at the coating site.

Studies carried out by the Applicant have shown that one parameter of exceptional importance in the preparation of binder/polymer mixtures is the granulometry of the polymer. The more finely dispersed the polymer, the shorter the agitation time. However, the production of polymers in the form of powder is more expensive the smaller the particle size of the powder. The value of optimising the mixing times by adjusting this parameter is therefore economically limited.

The Applicant has also tried mixing the polymer in liquid form with the bitumen. The mixing times are then very short and mixing is virtually instantaneous. On the other hand, the energy needed to soften the polymer is very considerable and the process takes a long time. All in all, the value is limited, unless large quantities of polymer are incorporated at viscosities which are low enough for the mixing with the bitumen to be instantaneous.

The aim of the invention is to provide a method of incorporating polymers in bituminous binders while avoiding the drawbacks of the known methods.

The invention relates in particular to a process for preparing a mixture containing bitumen and at least one polymer, in which bitumen and at least one polymer are mixed by extrusion.

By extrusion is meant any treatment which allows shearing of a paste-like mass and transportation thereof through an orifice suitable to produce a shaped section. In the process according to the invention, the mixing ensures that the mix of bitumen and polymer introduced separately into the extruder is homogeneous. These operations may be carried out using one or more Archimedes screws.

In the case of an extruder with at least two screws, the latter may rotate in the same direction or in opposite directions. In any case, experiments have shown that mixing was complete in a few dozen seconds. Although no particular screw profile is needed, the skilled man will be able to determine the profiles which are appropriate to optimise the rates and effectiveness of the mixing.

Unless stated otherwise, all the percentages given are by mass.

Some optional features of the invention, which may be additional or alternative, are recited below:

Bitumen in liquid form and at least one polymer in molten form are mixed by extrusion.

The polymer is selected from among a plastomer, an elastomer, a thermosetting resin and mixtures thereof.

The polymer is a plastomer selected from among the polyethylenes, polypropylenes and other polyolefins, the polystyrenes and all copolymers obtained by reacting any monomer with a polyolefin and/or with styrene.

The elastomer is a natural or synthetic elastomer, preferably selected from among the copolymers comprising amounts of styrene, butadiene or any other diene, acrylonitrile, isoprene, chloroprene, acrylates, methacrylates, ethylene, propylene or isobutene.

The elastomer is in the form of particles of rubber obtained by grinding up new or waste rubber.

The mixture contains a stabiliser for the polymer.

The stabiliser comprises at least sulphur and/or a sulphur donor and/or a vulcanisation activator and/or a vulcanisation accelerator or at least one peroxide or at least one metal salt.

The proportion of stabiliser is between 1 and 20% based on the polymer, preferably between 3 and 10%.

The temperature of the mixture may be adjusted to different values along the extrusion cavity between a zone of introduction of the ingredients and an outlet orifice, and is at its maximum for example in the introduction zone and at it minimum in the vicinity of the outlet orifice.

The mixture obtained by extrusion is a master batch with a high level of polymer which is intended to be diluted in a bitumen to produce a bituminous binder.

The amount of polymer in the master batch is between 10 and 90%, preferably between 20 and 60%.

The invention also relates to a master batch obtained by the process described above, and the use of a master batch of this kind for producing, by dilution, a bituminous binder which may be anhydrous or emulsified, fluxed or non-fluxed.

According to Advantageous Features:

The ratio of the master batch to the final binder is between 5 and 80%, preferably between 10 and 40%.

The hot master batch is diluted immediately after extrusion.

The master batch is cooled and optionally granulated before dilution.

The binder is brought into contact with solid mineral fragments after dilution.

The master batch and the diluting bitumen are brought into contact simultaneously with solid mineral fragments.

One advantage of using an extruder is the possibility of varying the operating temperature along the barrel in which the screw rotates. It has been found that a temperature above 160° C. was preferable in the case of a trisequenced styrene-butadiene-styrene copolymer (SBS), in the feed and mixing zones, in order to ensure that the polymer is softened. In the transfer zones and in the vicinity of the extrusion die, the temperature can usefully be lowered in order to promote cooling.

According to the invention, the master batch may be used hot, directly after extrusion, or cold after cooling and optional granulation. Using it hot is useful when the master batch is immediately diluted using a continuous or discontinuous method. If the master batch is to be stored before being diluted, cooling and granulation are a way of avoiding the energy consumption associated with maintaining the temperature of the master batch and the investment in a very large capacity pump for supplying the final mixer with a highly viscous premix.

Depending on the type and quantity of polymer, the granules of mixture may be more or less sticky. To prevent them clumping together it may be useful to put in an anti-sticking agent. This may be selected from among the mineral fillers (silicas, talc, etc.), fats (fatty acid, stearates or other salts) or polymers (silicones, organofluorine polymers, polyethylene, etc.).

The anti-sticking agents may be added directly to the extruder. Preferably, however, hey are applied to the surface of the shaped section as it cools on leaving the extruder. For this purpose, substances capable of being dissolved or suspended in water will be chosen in particular.

Depending on the particular case the shaped sections will be very elastic, soft or hard. The granulator will be chosen accordingly.

The tests carried out have shown that, surprisingly, the size of the granules had little influence on the speed of manufacture of the finished binder by dilution. This represents a major difference from the incorporation of powder according to the prior art, in which the powder had to be as fine as possible.

Just as surprising is the considerable reduction in the dilution time needed to obtain a commercial binder, notably for the most polymer-rich products which require the longest mixing times, for which a factor of 4 was observed. Thus, in the case of a 70/100 bitumen containing 5% of SBS, the time needed to obtain a homogeneous dispersion drops from 70 minutes minimum to 5 to 20 minutes, depending on the method used.

Furthermore, the appearance of the binder is much smoother and more glossy. The “orange peel” appearance which is obtained with conventional processes is avoided. The features and advantages of the invention will be described in more detail in the following description, referring to the attached drawings.

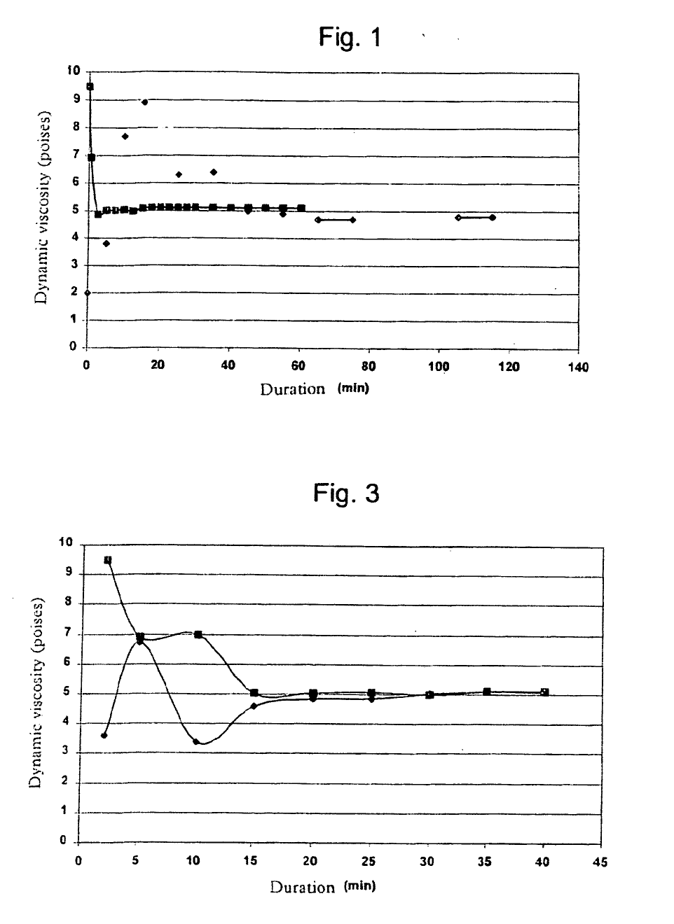

FIGS. 1 to 3 are graphs showing the variation in the viscosity of different bituminous binders as a function of the mixing time.

The examples that follow show that the binders obtained according to the invention not only have physical characteristics which are at least equivalent to those of the known binders but also have improved storage stability. This makes it possible to carry out premixing even with polymers which are of themselves incompatible with bitumen. Cooling of the master batch, which slows down the phase separation, further improves this property.

Dilution may immediately precede the use of the binder, simplifying the production of the bituminous mixture. Production may also be made easier by adding the master batch directly at the coating site at the same time as the bitumen which is used to adjust the final bitumen content.

As will be seen, the process considerably reduces the manufacturing times for the bituminous binders.

When carried out in extruders working on much smaller volumes than conventional reactors, the production of the master batch takes little energy. The heating of the material, caused by the very great shearing that occurs within the extruder, also helps to reduce the energy needed for the process.

Surprisingly, the tests carried out have shown that the time taken to obtain a homogeneous mixture varied little with the content of polymer in the master batch (cf. Example 3).

Consequently, the energy gain will be much greater, the higher the polymer content.

The gain both in energy and in the production rates is even more marked when particles of rubber are incorporated.

In this case it is possible to incorporate the additives specified in FR 2. 619 821 A at the moment of extrusion in order to facilitate the dispersion. The production of the finished binder then takes about I minute of extrusion and 30 minutes dilution, as opposed to 3 hours according to the process in the prior art document.

Finally, the performance of the binders containing elastomeric diene polymers can be brought to an optimum level by using a so-called vulcanisation system which may be used to stabilise the dispersion and reduce the quantities of polymer needed to obtain the desired characteristics of these binders.

FR 2 617 491 A describes a process in which the content of vulcanising agent is roughly 20%, based on the polymer.

The addition of such amounts to the extruder may result in excessive vulcanisation, leading to solidification. A content of less than or equal to 5% is therefore preferred in the present invention (cf. Example 4). This results in an environmental gain, because the vulcanisation systems contain sulphur compounds liable to produce H₂S during the reaction. The waste emissions are thus reduced. Furthermore, placing an exhauster above the extruder is a simple way of preventing any discharge into the environment.

The dilution of the vulcanised master batches takes place under the same conditions as that of the nonvulcanised master batches. The characteristics of the binder obtained with these reduced contents of vulcanising agent are identical to those obtained by the process described in FR 2 617 491 A.

The examples that follow use a 70/100 bitumen and a linear SBS as sold by the company Kraton under the name 1101 CM.

In order to evaluate the mixing times needed to obtain the binders in question, measurements of dynamic viscosity as a function of time were carried out at 150° C. using a Brookfield Cap 1000 apparatus fitted with a size 3 cone plate.

### EXAMPLE 1

Two binders were prepared containing 5% SBS, one by directly mixing powdered SBS (mean diameter 1 mm) and bitumen (control), the other by the following steps (invention):

mixing 30% SBS and 70% bitumen in a single screw extruder, over a period of 20 to 40 seconds, the temperature being 180° C. throughout the extruder;

diluting the master batch obtained, which is kept at 160° C., to 16.7% in bitumen.

The results of the viscosity measurements are shown in FIG. 1, where the symbol ▪ corresponds to the invention and the symbol ♦ corresponds to the control.

The oscillations observed on the control curve result from the heterogeneity of the polymer dispersion, proving that the polymer is not fully dispersed. After this there is a viscosity plateau showing that the dispersion is uniform. The time taken to reach this plateau is taken as the dispersion time.

In the case of hot dispersion of the master batch, it is found that after 5 minutes dispersion the plateau has already been reached, whereas using the conventional method a period of 70 minutes is needed.

### EXAMPLE 2

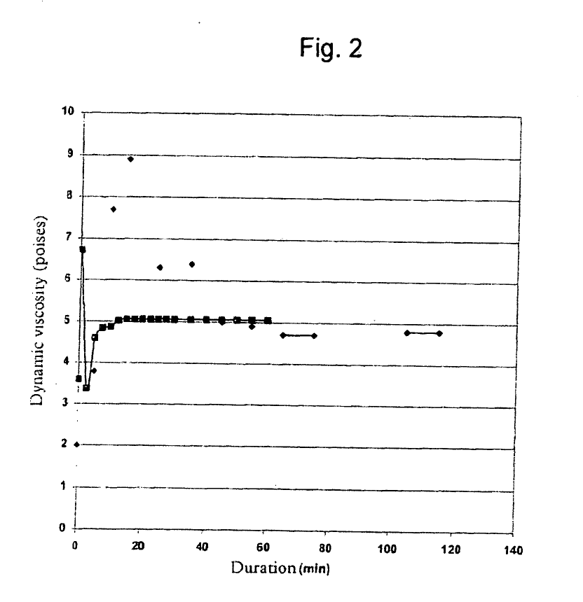

After extrusion, a master batch containing 40% SBS was left to stand until it reached ambient temperature, then granulated manually to a particle size of between 0.5 and 3 mm. The granules were dispersed in quantities of 12.5% in bitumen. The addition of the cold granules to the bitumen at 170° C. was carried out in one go over 10 seconds. The evolution of the viscosity is shown in FIG. 2 (symbol ▪), by comparison with the control curve in FIG. 1.

Even though the dispersion of the granules takes place more slowly than that of the master batch mix the time gain remains significant as a period of 20 minutes is sufficient, instead of the 70 minutes needed with the control.

### EXAMPLE 3

Two master batches containing 30 and 40% SBS, respectively, were produced, cooled to ambient temperature and then granulated to obtain granules between 0.5 and 3 mm in size. These master batches were diluted with bitumen at 170° C. to obtain a final polymer content of 5%.

The evolution of the viscosity is shown in FIG. 3 (▪=30%, ♦=40%).

Surprisingly, it seems that the SBS content of the master batch has very little influence on the rate of dispersion in the bitumen.

The usage characteristics of the binders obtained were compared with those of the control binder. No significant difference could be measured. However, better storage stability was observed.

### EXAMPLE 4

As already described, a valuable technical solution for optimising the quantities and performance of the diene polymers in the bitumen is the use of so-called vulcanisation systems, complex mixes of sulphur, sulphur donor, vulcanisation accelerator and vulcanisation activator.

In a twin-screw extruder bitumen was mixed with 20% SBS and 3% of a vulcanising composition according to FR 2 619 821 A, i.e. a ratio of vulcanising composition to polymer of 15%, as used in a conventional manufacturing process. The formation of a gel that blocked the extruder was immediate. Tests were therefore carried out using, respectively, two thirds and one third of this normal quantity. In both cases extrusion was possible with no difficulty at all. The master batches were cooled to ambient temperature.

Granulation of the master batch vulcanised with 2% of vulcanising composition was found to be difficult as a result of exceptional elasticity. The 1% mix presented no problems and was added to bitumen at 170° C. to obtain a binder containing 5.5% polymer.

Once again, the viscosity measurements indicate that the dispersion time is divided by 4, compared with conventional manufacture.

The physical characteristics of the binder obtained are identical to those of the conventional mixture and therefore in accordance with the internal specifications of the Applicant, as shown in the Table.

TABLE

| | Binder | Specification |
|---|---|---|
| Penetrability according to FS EN 1426 | 51 | 40-70 |
| Ball and ring temperature ° C. according to | 84.5 | >65 |
| French Standard EN1427 | | |
| % of polymer | 5.5 | 5 |
| Storage stability according to internal method | yes | no |
| Cohesion according to FS T 66.037 | | |
| Cohesion max. | 1.6 | >1.5 |
| Temperature max. ° C. | 40 | 40 |
| Temperature range ° C. | 39 | — |

Dividing the quantities of vulcanising agent by 3 obviously had an extremely positive impact in environmental and economic terms. The limited atmospheric emissions connected with its use were also easily sucked up and fixed in an exhauster system surmounting the extruder. Centralising the production of the vulcanised master batches also avoids the need for corresponding investment costs in factories for producing the finished binders. Moreover, these factories can also adopt a technology which is of value both economically and technically, with low environmental impact.

1. Method of preparing a mix containing bitumen and at least one polymer, wherein the bitumen and at least one polymer are mixed by extrusion, characterised in that the temperature of the mix is adjusted to different values along the extrusion cavity between an introduction zone for the ingredients and an outlet orifice.

2. Method according to claim 1, wherein bitumen in liquid form and at least one polymer in molten form are mixed by extrusion.

3. Method according to one of claims 1 and 2, wherein the polymer is selected from among a plastomer, an elastomer, a thermosetting resin and mixtures thereof.

4. Method according to claim 3, wherein the polymer is a plastomer selected from among the polyethylenes, polypropylenes and other polyolefins, polystyrenes and all polymers obtained by reacting any monomer with a polyolefin and/or with styrene.

5. Method according to claim 3, wherein the elastomer is a natural or synthetic elastomer, preferably selected from among the copolymers containing units of styrene, butadiene or any other diene, acrilonitrile, isoprene, chloroprene, acrylates, methacrylates, ethylene, propylene, isobutene.

6. Method according to claim 3, wherein the elastomer is in the form of particles of rubber obtained by grinding up new or waste rubber.

7. Method according to one of the preceding claims, wherein the mixture contains a stabiliser for the polymer.

8. Method according to claim 7, wherein the stabiliser contains at least sulphur and/or a sulphur donor and/or a vulcanisation activator and/or a vulcanisation accelerator or at least one peroxide or at least one metal salt.

9. Method according to one of claims 7 and 8, wherein the amount of stabiliser by mass is between 1 and 20% based on the polymer, preferably between 3 and 10%.

10. Method according to one of the preceding claims, wherein the temperature is at its maximum in the introduction zone and at its minimum in the vicinity of the outlet orifice.

11. Method according to one of the preceding claims, wherein the mix obtained by extrusion is a master batch with a high polymer content intended to be diluted in a bitumen to produce a bituminous binder.

12. Method according to claim 11, wherein the amount by mass of polymer mass in the master batch is between 10 and 90%, preferably between 20 and 60%.

13. Master batch obtained by the process according to one of claims 11 and 12.

14. Use of a master batch according to claim 13 for the production by dilution of a bituminous binder, which may be anhydrous or in emulsion, fluxed or non-fluxed.

15. Use according to claim 14, wherein the mass ratio of the master batch to the finished binder is between 5 and 80%, preferably between 10 and 40%.

16. Use according to one of claims 14 and 15, wherein the hot master batch is diluted directly after extrusion.

17. Use according to one of claims 14 and 15, wherein the master batch is cooled and optionally granulated before dilution, with the use of anti-sticking agents if desired.

18. Use according to one of claims 14 to 17, wherein the binder is brought into contact with solid mineral fragments after dilution.

19. Use according to one of claims 14 to 17, wherein the master batch and the diluting bitumen are simultaneously brought into contact with solid mineral fragments.
